(19) United States
(12) Patent Application Publication
(10) Pub. No.: US 2021/0141754 A1
(43) Pub. Date: May 13, 2021

(54) PROJECTOR DOCKING DEVICES WITH MULTIPLE PROJECTOR PORTS

(71) Applicant: Hewlett-Packard Development Company, L.P., Spring, TX (US)

(72) Inventors: Richard S. Lin, Spring, TX (US); Baosheng Zhang, Spring, TX (US); Fangyong Dai, Spring, TX (US)

(73) Assignee: Hewlett-Packard Development Company, L.P., Spring, TX (US)

(21) Appl. No.: 17/042,369

(22) PCT Filed: Jul. 18, 2018
(86) PCT No.: PCT/US2018/042726

§ 371 Date: Sep. 28, 2020

(51) Int. Cl. G06F 13/40; H04N 5/268; H04N 9/31

(52) U.S. Cl. CPC G06F 13/4027; H04N 9/3147; H04N 5/268

(57) ABSTRACT

In one example in accordance with the present disclosure, a projector docking device is described. The projector docking device includes an input to couple the projector docking device to a computing device. Information to be visualized through a projector is passed via the input. The projector docking device also includes multiple docking stations. Each docking station includes at least a first port to receive a projector that displays information generated on the computing device.

### BACKGROUND

Projectors are display devices that can be coupled to a computing device. A projector, once coupled to a computing device, may enlarge the display of a computing device, thus making displayed information viewable to a larger group of individuals, for example in a conference presentation room. In another example a projector may be used to provide a secondary display to the primary display of a computing device. In this case, a user may view additional information in addition to that which is presented on a primary screen of the computing device.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a projector docking device with multiple projector ports, according to an example of the principles described herein.

FIGS. 2A and 2B are diagrams of a projector docking device with multiple projector ports, according to an example of the principles described herein.

FIG. 3 is a block diagram of a projector docking device with multiple projector ports, according to another example of the principles described herein.

FIG. 4 is a diagram of a projector docking device with multiple projector ports, according to an example of the principles described herein.

FIG. 5 is a diagram of a projection system with a projector docking device with multiple projector ports, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, projectors can be used to either duplicate and enlarge a display originating from a computing device, or can be used to extend the display and thus present additional material. For example, a user presenting to a large audience may use a projector to duplicate information on a computing screen and enlarge it such that the entire audience can view the presentation.

In another example, a user may wish to extend a display such that multiple applications on a computing screen can be viewed at the same time. For example, a word processing document could be opened and displayed on one screen and a spreadsheet could be opened and displayed on another screen. Such dual screen presentation may increase the efficiency of work for a user.

While such projectors are inarguably useful in the options they present for information display, some additional developments may increase their overall usability. For example, it may be the case that a user desires to couple multiple projectors to a computing device. Doing so may be difficult as complex cable arrangements may be required to facilitate such a connection. Moreover, in some examples, a user may desire a second display, but it may be impractical to transport a second monitor. For example, while traveling, a user may transport their laptop computing device with its screen and may desire for a second display window without having to haul along an entirely second computer screen and the complex connection components that may be associated therewith.

Accordingly, the present specification addresses this and other issues. Specifically, the present specification describes a docking device that can receive multiple projectors. That is, the docking device includes multiple docking stations, with each docking station able to receive a projector. In this fashion, a projector could be coupled to the computing device to provide an extended display, rather than a bulky monitor. The docking device also provides a simple connection interface for a projector, which projector may be a pico projector. Such a pico projector and simple docking device provide a simple and easily transportable docking station for multiple projectors.

Specifically, the present specification describes a projector docking device. The projector docking device includes an input to couple the projector docking device to a computing device. In this example, information to be visualized through a projector is passed via the input. The projector docking device also includes multiple docking stations. Each docking station includes at least a first port to receive a projector that displays the information generated on the computing device.

The present specification also describes a projection system. The projection system includes a projector docking device. The system also includes multiple modular projectors, each of which is coupled to a port of a different docking station.

According to another example, the projector docking device includes the input through which data to be visualized is transmitted and through which control data for the projectors is transmitted. The projector docking device also includes multiple docking stations, with each station including 1) the first port and 2) a second port to couple a monitor to the computing device. In this example, the projector docking device includes a switch to selectively couple the computing device to one of the first port and the second port.

In summary, using such a projector docking device 1) enables multiple high resolution displays; 2) expands a display of a computing device; 3) provides flexibility in display options; and 4) is portable for easy transport. However, the devices disclosed herein may address other matters and deficiencies in a number of technical areas.

As used in the present specification and in the appended claims, the term “docking station” refers to a section of the docking device wherein projectors/monitors can be coupled. For example, one docking station allows one projector or one monitor to be plugged therein. A docking device with three docking stations has three sections, each of which can receive either a projector or a monitor.

Turning now to the figures, FIG. 1 is a block diagram of a projector docking device (100) with multiple projector ports (106), according to an example of the principles described herein. The projector docking device (100) is a device that receives projectors, which projectors can enlarge, duplicate, and/or extend a display of a computing device. That is, a projector is a display device that receives as input, data from a coupled computing device.

To facilitate the enlargement, duplication, and/or extension of the displayed information, the projector docking device (100) includes an input (102) that couples the projector docking device (100) to a computing device. Via this input (102), information to be displayed is passed through the circuitry of the projector docking device (100) to coupled projectors. The input (102) may be of varying types and protocols. For example, the input (102) may support a universal serial bus (USB) protocol. Such an input (102) facilitates the high, or super, speed transmission of information generated on the computing device and to be visualized on a projector.

Via the input (102), control data may also be transmitted. That is, a controller, which may be in the computing device, may adjust the logical display of the coupled projectors. For example, a bandwidth allocated to each projector may be altered based on the number of projectors that are coupled to the docking device (100). Accordingly, the input (102) transmits this information to the controller. In another example, the logical display of the projectors may be dependent upon which of the first ports (106) the projector is coupled to, and where the docking device (100) is in relation to the computing device. Accordingly, the projector docking device (100) may include hardware components to determine active ports (106) and relative position of the projector docking device (100) and may pass such information to a controller of the computing device such that an associated display of projectors can be altered.

The projector docking device (100) also includes multiple docking stations (104). A docking station (104) refers to a junction through which a projector or monitor can be coupled to a computing device. In one example, the docking station (104) includes a first port (106). In other examples, the docking station (104) may include additional ports. An example of a docking station (104) with additional ports is provided below in connection with FIGS. 3-5.

The first port (106) of each docking station (104) can receive a projector. In some examples, the first port (106) is a multi-protocol port (106). That is, via the first port (106) different protocols may be used. As a specific example, the first port (106) may have multiple differential pairs of transmission lines capable of supporting one super-speed protocol at a given time, which super-speed protocols may be of varying types. By accommodating different super-speed protocols, devices that implement the different protocols can be accommodated.

As a specific example, the first port (106) may be a USB type-c port which can use any one of a USB protocol, an alternative mode protocol, such as an alternative mode specifically tailored for use with display devices. In this example, the alternative modes may be specific to display devices. For example, a display device specific alternative mode may provide for up to 4 k resolution and may support up to three modular projectors. In yet another example, the first port (106) may be used with other types of protocols. By accommodating various communication protocols, the first ports (106) may communicate with projectors that implement these different protocols and may be able to transmit visual information via a number of different parameters.

As described herein, the projector docking device (100) of the present specification allows for the use of multiple high resolution displays. Specifically, this is accommodated by including multiple ports (106) on the docking device (100). The multiple ports (106) also facilitate the expandability, i.e., how many projector devices, of the projection system. Such a projector docking device (100) is also small and portable, allowing for the use of multiple projectors, even at times when space is limited for the storage and transportation of such devices, such as air travel.

FIGS. 2A and 2B are diagrams of a projector docking device (100) with multiple projector ports (106), according to an example of the principles described herein. Specifically, FIG. 2A is a top view of the projector docking device (100) and FIG. 2B is an isometric view of the projector docking device (100). Note that in FIGS. 2A, 2B and others, the components are not drawn to scale. That is, some components have been enlarged to show detail.

FIGS. 2A and 2B depict the docking stations (104-1, 104-2, 104-3) that make up the projector docking device (100). While FIGS. 2A and 2B depict three docking stations (104-1, 104-2, 104-3) on the projector docking device (100) with each having a first port (106-1, 106-2, 106-3), the projector docking device (100) may include any number of docking stations (104) and accordingly, any number of ports (106).

FIG. 2A also depicts an input (102) port. In the example depicted in FIG. 2A, the input (102) may be a port into which a cable is plugged. In another example, such as that depicted in FIG. 2B, the input (102) may include a cable permanently or removably affixed to a housing of the projector docking device (100) with a connector disposed on the end.

In some examples, the bandwidth allocated to a projector is determined based on a number of active docking stations (104). Or rather, the bandwidth allocated to a projector is determined based on a number of projectors that are coupled to the docking device (100). For example, it may be that the docking device (100) can support 2 k resolution on each of three coupled projectors, which is when three docking stations (104) are active. In another example, if a single docking station (104) is active, the docking device (100) may support 4 k resolution on that single projector. Accordingly, the projector docking device (100) may include circuitry to detect active ports (106) and to pass control information pertaining thereto to a controller of a coupled computing device. In these examples, the projector docking device (100) can receive more than one projector. For example, the docking device (100) may receive as many projectors as there are ports (106) to receive projectors.

In some examples, in addition to the docking ports (106), at least one docking station (104) may include a swivel (208) to allow adjustment of the coupled projector. That is, during use the display area of adjacent projectors may overlap with one another. Accordingly, the swivel (208) corresponding to the different docking stations (104) may allow the projector and its corresponding output to rotate such that edges of the adjacent projections are aligned. Thus an overlap of adjacent displays is prevented. FIG. 5 below provides an example of such adjustment to prevent image overlay.

FIG. 2B clearly depicts the input (102). In this example, the input (102) includes a cable that is permanently or removably coupled to a housing of the projector docking device (100). At the end of the input cable is a connector that can be inserted into a receptacle, or port, of the computing device. In some examples, the projector docking device (100) draws power from the computing device via the input (102). In other examples, the projector docking device (100) includes an internal power supply such as a rechargeable battery. In other examples, an external AC power supply may be connected via a separate jack or a dedicated USB type-c port of the projector docking system (100) to deliver such power.

Including multiple docking stations (104) on a single projector docking device (100) may increase productivity. That is, a user with a single display provided via a computing device may be less productive on account of the reduced screen space. Accordingly, by providing for additional coupled projectors, a user may have an enlarged screen space, thus improving their ability to complete tasks.

Moreover, by being small and portable, the docking device (100) may provide enlarged, duplicated, or extended displays when they otherwise would be unavailable. For example, during travel the space available to store and transport projectors and the associated cabling may be limited, and moreover may be complex. Due to the small size of the projector docking device (100), a user can accommodate facile connection of any number of projector devices, all without requiring significant amounts of storage space.

FIG. 3 is a block diagram of a projector docking device (100) with multiple projector ports (106), according to another example of the principles described herein. In this example, the projector docking device (100) includes the input (102), docking station (104), and first port (106) as described above in connection with FIG. 1.

In this example, each docking station (104) includes additional components. For example, each docking station (104) may include a second port (310). The second port (310) is to couple a monitor to the computing device. As with the projector, the monitor is to display information such as video, photos, computer applications, etc. that are generated on the coupled computing device. Put another way, at each docking station (104) a user may elect to couple a monitor, a projector, or nothing. As such, a user can tailor a display system to their desire. That is, a user may couple one extra monitor to a second port (310) of one docking station (104) and may couple a projector to a first port (106) of another docking station (104). While specific reference is made to a particular configuration of coupled display devices (i.e., monitors and projectors), a wide variety of combinations of monitors and projectors could be implemented in line with the current projector docking device (100).

In some examples, the first port (106) may be of a different type than the second port (310). For example, as described above, the first port (106) may be a multi-protocol port such as a USB type-c port. The second port (310) may be a different type of port such as a video graphics array (VGA) port or a digital visual interface (DVI) port. While specific reference is made to particular types of display ports that may be used as the second port (310) various other types of ports may be used in accordance with the principles described herein.

Providing different types of ports (106, 310) allows for even more possibilities regarding coupled display devices. That is, the second port (310) provides even more connection types, thus providing for the coupling of other types of display devices such as computer monitors, televisions, etc.

In some examples, each docking station (104) includes a switch (312). The switch (312) selectively couples the computing device to one of the first port (106) and the second port (310). Put another way, the first port (106) and the second port (310) may be multiplexed, together such that visualization data and control signals are passed to just one of the two ports (106, 310) of a particular docking station (104) at any given moment.

Selection of one of the first port (106) and the second port (310) may facilitate the selection and use of certain communication protocols. Accordingly, in addition to selectively coupling one of the first port (106) and the second port (310) to the associated computing device, the projector docking device (100) may also pass information relating to which of the first port (106) and second port (310) is active, or has a display device connected. A controller within the computing device may then pass visualization information based on the detected active port. For example data may be sent using certain protocols and/or at certain speeds based on the connection.

In some examples, the projector docking device (100) may include circuitry (314) for determining which ports are active, or rather which ports (106, 310) have received a projector or monitor connection. As described above, such information may be used by a controller within a computing device to determine how to manage the data transmission between that port (106, 310).

FIG. 4 is a diagram of a projector docking device (100) with multiple projector ports (106), according to an example of the principles described herein. For simplicity, the indication of the distinct docking stations (FIG. 1, 104) has been omitted from FIG. 4. However, as described above, each docking station (FIG. 1, 104) includes the first port (106) and the second port (310) with their associated switch (312) as depicted in FIG. 4. In FIG. 4, the switches (312-1, 312-2, 312-3) are indicated in dashed lines to indicate their location internal to the housing of the projector docking device (100). As clearly depicted in FIG. 4, each switch (312) is coupled to both the first ports (106) and the second ports (310) and selectively couples one of these ports to the computing device.

FIG. 5 is a diagram of a projection system (514) with a projector docking device (FIG. 1, 100) with multiple projector ports (106), according to an example of the principles described herein. As used in the present specification, the projection system (514) includes the projector docking device (FIG. 1, 100) with the projectors (516-1, 516-2) that are coupled thereto. FIG. 5 clearly depicts the simultaneous coupling and use of multiple projectors (516-1, 516-2) to the docking device (FIG. 1, 100). In some examples, the projectors (516) that are coupled to the projector docking device (FIG. 1, 100) may be pico projectors (516). A pico projector (516) is a small projector that, for example, may be held within a user's hand. In some examples, a pico projector (516) may be referred to as a pocket projector or a mobile projector.

FIG. 5 also clearly depicts the operation of the swivels (208) to which the first ports (106) and the projectors (516) are coupled. That is, as described above, were the projectors (516) not rotatable when disposed on the docking device (FIG. 1, 100), their associated display outputs may overlap. This overlap may be inefficient and may result in images that are not discernible. Accordingly, a swivel (208), in this example a third swivel (208-3) has allowed an associated projector (516-2) to rotate such that its corresponding output display can rotate and thereby not overlap with the immediately adjacent projection.

In some examples, as depicted in FIG. 5, the ports (106) may be disposed on a single surface, such as a top surface of the docking device (FIG. 1, 100). In this example, the projectors (516) are disposed on that surface. However, in other examples, the ports (106) may be disposed on another surface, or different ports (516) may be disposed on different surfaces.

Moreover, in some examples such as that depicted in FIG. 5, the projectors (516) may be disposed directly on the surface of the projector docking device (FIG. 1, 100). That is, the projector (516) housing may rest on the projector docking device (FIG. 1, 100) housing. Thus, the projector docking device (FIG. 1, 100) provides a surface on which a projector (516) rests. In other examples, the projectors (516) may be tethered to the ports (106). That is, a cable which may be affixed to a projector (516) may be inserted into the ports (106) and couple the projector (516) to the projector docking device (FIG. 1, 100).

Moreover, while FIG. 5 depicts a certain configuration of projectors (516) disposed on the projector docking device (FIG. 1, 100) and no monitors coupled thereto, the projector docking device (FIG. 1, 100) can accommodate any number of projectors/monitors in any configuration.

In summary, using such a projector docking device 1) enables multiple high resolution displays; 2) expands a display of a computing device; 3) provides flexibility in display options; and 4) is portable for easy transport. However, the devices disclosed herein may address other matters and deficiencies in a number of technical areas.

What is claimed is:

1. A projector docking device, comprising:
an input to couple the projector docking device to a computing device, wherein information to be visualized through a projector is passed via the input; and
multiple docking stations, wherein each docking station comprises at least a first port to receive a projector that displays information generated on the computing device.

2. The device of claim 1, wherein at least one first port swivels to facilitate adjustment of a display of a coupled projector.

3. The device of claim 1, wherein each docking station further comprises a second port to couple a monitor to the computing device, wherein the monitor displays information generated on the computing device

4. The device of claim 3, further comprising a switch to selectively couple the computing device to one of the first port and the second port.

5. The device of claim 3, wherein the second port is a different type port than the first port.

6. The device of claim 1, wherein the first port is a multi-protocol port.

7. The device of claim 1, further comprising circuitry to detect ports that have received a projector connection.

8. The device of claim 1, wherein each docking station provides a bandwidth based on a number of projectors coupled to the docking device.

9. A projection system, comprising:
a projector docking device comprising:
an input to couple the projector docking device to a computing device, wherein information to be visualized through a projector is passed via the input;
multiple docking stations, wherein each docking station comprises at least a first port to receive a projector that displays information generated on the computing device; and
multiple modular projectors, each modular projector coupled to a port of a different docking station.

10. The projection system of claim 9, wherein a modular projector is disposed on top of, and directly coupled to, a corresponding docking station during use.

11. The projection system of claim 9, wherein a modular projector is coupled via a cable to a corresponding docking station.

12. The projection system of claim 9, wherein the modular projectors are pico projectors.

13. A projector docking device, composing:
an input to couple the projector docking device to a computing device, wherein the input transmits:
information to be visualized through projectors; and
control information for the projectors;
multiple docking stations, wherein each docking station comprises:
a first port to couple a projector to the computing device, wherein the projector displays information generated on the computing device;
a second port to couple a monitor to the computing device, wherein the monitor displays information generated on the computing device; and
a switch to selectively couple the computing device to one of the first port and the second port.

14. The device of claim 13, wherein each port swivels to facilitate adjustment of a display of each coupled projector.

15. The device of claim 13, wherein the first port is a multi-protocol port.
